(19) United States
(12) Patent Application Publication
(10) Pub. No.: US 2006/0133775 A1
(43) Pub. Date: Jun. 22, 2006

(54) METHOD OF STORAGE MEDIUM MANAGEMENT AND VIDEO RECORDING SYSTEM AND STORAGE SYSTEM THEREOF

(76) Inventor: Chi-Cheng Ju, Hsin-Chu City (TW)

Correspondence Address: IBM CORPORATION;INTELLECTUAL PROPERTY LAW, 11400 BURNET ROAD, AUSTIN, TX, 78758, US

(21) Appl. No.: 10/905,266

(22) Filed: Dec. 22, 2004

(51) Int. Cl. H04N 5/91

(52) U.S. Cl. 386/95

(57) ABSTRACT

A method of storage medium management includes providing a storage medium; storing a plurality of encoded bit streams within the storage medium; monitoring a remaining storage space available within the storage medium; and if the remaining storage space is below a threshold, transcoding a stored bit stream within the storage medium being encoded at a first bit rate to a second bit rate. When transcoding the stored bit stream to a second bit rate being lower than the first bit rate, the method of storage medium management increases the remaining space available within the storage medium.

### BACKGROUND

The invention relates to data storage systems, and more particularly, to managing encoded data stored on a storage medium.

Recently, video recording apparatuses such as a video cassette recorders (VCRs) and Digital Versatile Disc (DVD) recorders have been widely used for recording movies or video programs. Such recording and controlling apparatuses reproduce still pictures or moving pictures from a storage medium to output them to a screen. Additionally, a plurality of pictures and associated audio can also be recorded onto the storage medium.

Usually, recording is carried out utilizing several recording modes including: High Picture Quality (XP), Standard (SP), Long Play (LP), and Extra Long Play (EP). The different recording modes correspond to different encoding bit rates. From highest bit rate to lowest bit rate, the order of different recording modes is: XP, SP, LP and then EP. Therefore, the XP mode has the highest encoding bit rate and the EP mode has the lowest encoding bit rate. Since the video quality of the encoded video is proportional to the bit rate, the XP mode has the best video quality and the EP mode has the worst video quality. Although XP has the best video quality, its high bit rate produces a large bit stream of encoded video and this reduces the number of video bit streams that can be recorded on the storage medium such as a magnetic medium or a DVD disk. On the other hand, although EP has the worst encoding video quality, its low bit rate produces a small bit stream of encoded video and this increases the number of video bit streams that can be recorded on the storage medium. Hence, how to manage the recording mode when encoding a video to achieve efficient recording medium storage management is a key issue in a video recoding system.

### SUMMARY

Methods and systems of storage medium management are provided. An exemplary embodiment of a method of storage medium management is disclosed comprising: providing a storage medium; storing a plurality of encoded bit streams within the storage medium; monitoring a remaining storage space available within the storage medium; and if the remaining storage space is below a threshold, transcoding a stored bit stream within the storage medium being encoded at a first bit rate to a second bit rate.

An exemplary embodiment of a storage system is disclosed comprising a storage medium; a codec coupled to the storage medium for storing a plurality of encoded bit streams within the storage medium; and a storage medium management module coupled to the storage medium and the codec comprising: a free space monitor for monitoring a remaining storage space available within the storage medium; and a controller for controlling the codec to transcode a stored bit stream within the storage medium being encoded at a first bit rate to a second bit rate if the remaining storage space is below a threshold.

An exemplary embodiment of a video recording system is disclosed comprising a storage medium; a codec coupled to the storage medium for encoding an incoming video signal to form a plurality of encoded video bit streams within the storage medium; and a storage medium management module coupled to the storage medium and the codec comprising: a free space monitor for monitoring a remaining storage space available within the storage medium; and a controller for controlling the codec to transcode a stored video bit stream within the storage medium being encoded at a first bit rate to a second bit rate if the remaining storage space is below a threshold.

### BRIEF DESCRIPTION OF DRAWINGS

FIG. 1 is a block diagram of an embodiment of a storage system.

FIG. 2 shows a plurality of bit streams being stored on the DVD disc of FIG. 1 before and after transcoding by the codec according to a first exemplary embodiment.

FIG. 3 shows bit streams stored on the DVD disc of FIG. 1 before and after transcoding by the codec according to a second exemplary embodiment.

FIG. 4 shows a flowchart describing an embodiment of operations of storage medium management.

### DETAILED DESCRIPTION

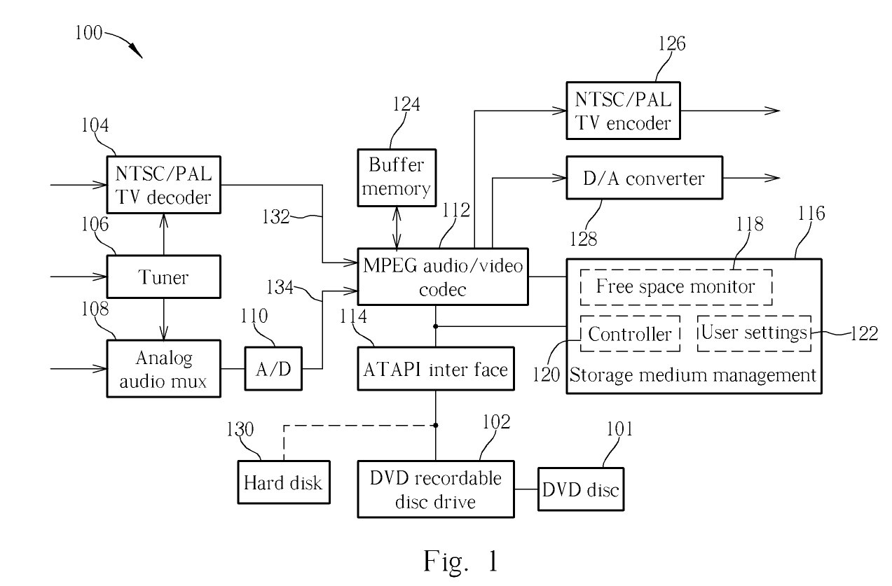

FIG. 1 is a block diagram of an exemplary embodiment of a storage system 100. The storage system 100 is a video recording system 100 for storing encoded audio/video bit streams on a digital video disc (DVD) recordable disc 101 inserted into a DVD recordable disc drive 102. In this way, encoded audio/video bit streams can be recorded onto a DVD disc 101, such as a DVD-RAM, a DVD-R, a DVD+R, a DVD-RW or a DVD+RW disc. However, as will be apparent to a personal of ordinary skill after reading this description, other embodiments of the present disclosure are also possible.

In FIG. 1, the video recording system 100 includes the DVD recordable disc drive 102, the DVD disc 101, an NTSC/PAL television (TV) decoder 104, a tuner 106, an analog audio mux 108, an analog to digital (A/D) converter 110, an MPEG audio/video coder and decoder (codec) 112, buffer memory 124 for use by the codec 112, an ATAPI interface 114, an NTSC/PAL TV encoder 126, a D/A converter 128, and a storage medium management module 116.

During television program recording operations, the NTSC/PAL TV decoder 104, the tuner 106, the analog audio mux 108, and the A/D converter 110 together allow a user to select a particular television channel for recording a TV program onto the DVD disc 101. A video signal 132 and an audio signal 134 are received by the MPEG codec 112 and correspond to the user selected television channel. The MPEG codec 112 encodes the incoming video/audio signals 132, 134 at a predetermined bit rate. For example, in some embodiments, the MPEG codec 112 uses the highest quality bit rate such as provided by High Picture Quality (XP). The encoded bit stream corresponding to the TV program that the user selected using the tuner 106 is stored onto the DVD disc 101 via the ATAPI interface and the DVD recordable disc drive 102.

During program playback operations, the MPEG codec 112 retrieves and decodes a selected encoded bit stream from the DVD disc 101, and the NTSC/PAL TV encoder 126 and D/A converter 128 generate TV signals that can be outputted to an external display device such as a television (not shown).

In the example of FIG. 1, the storage medium management module 116 manages the encoded bit streams stored on the DVD disc 101 to achieve efficient recording medium storage management during non-recording operations. To perform this task, the storage medium management module 116 comprises a free space monitor 118 and a controller 120. The free space monitor 118 continuously monitors a remaining storage space available within the DVD disc 101. The controller 120 controls the codec to transcode a stored video bit stream on the DVD disc 101 being encoded at a first bit rate to a second bit rate if the remaining storage space monitored by the free space monitor 118 is below a first threshold.

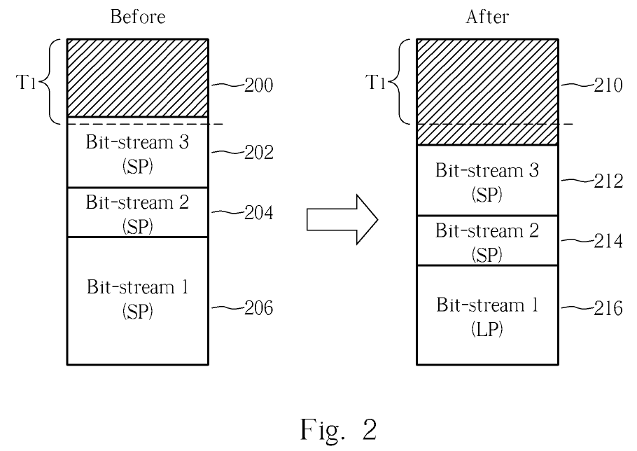

FIG. 2 shows a plurality of bit streams being stored on the DVD disc 101 before and after transcoding by the codec 112 according to a first exemplary embodiment. As shown in the “Before” column of FIG. 2, initially three bit streams 202, 204, 206 are stored on the DVD disc 101. Each of the bit streams 202, 204, 206 is encoded with the SP bit rate. The free space monitor 118 monitors the amount of free space 200 remaining on the DVD disc 101. In this case, when the remaining storage space 200 drops below a threshold T1, the controller 120 controls the MPEG codec 112 to transcode one of the bit streams 202, 204, or 206 stored on the DVD disc from the original SP bit rate to a lower bit rate of LP. In some embodiments, in order to maximize the amount of resulting free space, the selection of which bit stream is transcoded is performed according to the bit rate and the storage size of the bit streams. That is, the bit stream having the highest quality (e.g., the highest bit rate) of all the bit streams stored on the DVD disc 101 is selected for transcoding. If there are plurality of bit streams all recorded at this high quality level, for example three bit streams 202, 204, 206 all encoded using SP as shown in FIG. 2, the controller 120 firstly determines the largest sized bit stream within the storage medium that is encoded at the highest bit rate (e.g., SP in FIG. 2), and then selects that largest sized bit stream (e.g., bit stream 206 in FIG. 2) as the stored bit stream for transcoding. As shown in the “After” column of FIG. 2, after transcoding the first bit stream 206, the remaining space 210 is increased and is no longer below the threshold T₁.

By transcoding the largest SP encoded bit stream on the DVD disc 101 from an SP bit rate to an LP bit rate, the storage medium management module 116 increases the size remaining space available 210 on the DVD disc 101. Because, the transcoding operation is performed only after the remaining space 200 has dropped below a predetermined threshold T1, the user is able to initially record (and playback) all programs using high quality bit rates. Therefore, the user does not need to use lower quality when recording programs to prevent the DVD disc 101 from running out of disc space later on. Instead, the user can initially use high quality for recording all programs. If the remaining space does begin to get low, the storage medium management module 116 will automatically transcode a stored bit stream previously recorded at a high bit rate to a lower bit rate and thereby increase the free space of the DVD disc 101. If after transcoding the remaining space 210 does not exceed the threshold T1, the storage medium management module can repeat the process to transcode another bit stream and thereby further increase the remaining space 210.

As mentioned, other embodiments according to the present disclosure are also possible. For example, the present disclosure is not limited to DVD recorders. In some embodiments, the DVD recordable disc drive 102 and DVD disc 101 shown in FIG. 1 are replaced with a storage medium such as a magnetic storage medium being a hard disk 130. The hard disk 130 could be implemented within the video recording system 100 or could be implemented within an external computer system (not shown). In general, the present disclosure is applicable to any storage system storing bit streams that can be encoded at different bit rates.

Additionally, other methods of selecting which of the encoded bit streams stored within the storage medium 101, 130 are possible. For example in other embodiments, the bit stream having the earliest date or longest time since creation could be utilized to select which bit stream is to be transcoded. That is, in FIG. 2, the oldest of the three bit streams 202, 204, 206 is selected for transcoding.

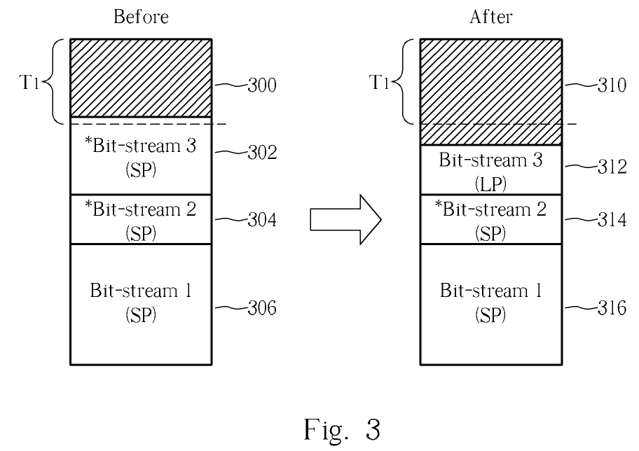

FIG. 3 shows bit streams stored on the DVD disc 101 before and after transcoding by the codec 112 according to a second exemplary embodiment. In some embodiments, as shown in the example of FIG. 1, the storage medium management module 116 further comprises a user settings module 122. The user settings module 122 allows the user to indicate which of the encoded bit streams within the storage medium can be transcoded by marking the encoded bit streams that can be transcoded as variable bit streams. For example, in FIG. 3, the variable bit streams are marked with a star (*) and include bit streams 302 and 304. In this way, the user can choose to preserve the high quality bit rates of some bit streams, such as bit stream 306. Bit streams not marked as variable bit streams will not be selected for transcoding by the storage medium management module 116.

As shown in the “Before” column of FIG. 3, initially three bit streams 302, 304, 306 are stored on the DVD disc 101. Each of the bit streams 302, 304, 306 is encoded with the SP bit rate, however only bit streams 302 and 304 are marked as variable bit streams. The free space monitor 118 monitors the amount of free space 300 remaining on the DVD disc 101. In this embodiment, when this remaining storage space 300 drops below a threshold T1, the controller 120 controls the MPEG codec 112 to transcode one of variable bit streams 302 or 304 stored on the DVD disc from the original SP bit rate to a lower bit rate of LP. In order to maximize the amount of free space that is created, the selection of which variable bit stream is transcoded is performed according to the bit rate and the storage size of the variable bit streams 302, 304. That is, the variable bit stream having the highest quality (e.g., the highest bit rate) of all the variable bit streams stored on the DVD disc 101 is selected for transcoding. If there are plurality of variable bit streams all recorded at this high quality level, for example two variable bit streams 302, 304 both encoded using SP as shown in FIG. 3, the controller 120 firstly determines the largest sized bit stream within the storage medium that is encoded at the highest bit rate (e.g., SP in FIG. 2), and then selects that largest sized bit stream (e.g., bit stream 302 in FIG. 2) as the stored bit stream for transcoding. As shown in the “After” column of FIG. 3, after transcoding the third bit stream 302 to form a smaller LP bit stream 312, the remaining space 310 is increased and is no longer below the threshold T₁. In some embodiments, in order to prevent further transcoding, the smaller LP bit stream 312, as shown in FIG. 3, can be no longer marked as a variable bit stream by the user or by the controller 120 automatically.

Assuming that the total storage size of the hard disc 130 or the DVD disc 101 is N MBs (Mega bytes), for example 50000 MBs, the predetermined threshold T₁ is used by the free space monitor 118 to allow the storage medium management to enter a storage efficient mode. For example, the threshold T₁ can be a percentage of the total storage size N such as 20% or a predefined size such as 10000 MBs. Therefore, when the remaining space M available on the storage medium 130, 101 is below the threshold T₁, the storage system 100 enters the storage efficient mode. It should also be noted that the remaining space 200, 300 may not necessarily be concurrent as shown in FIG. 2 and FIG. 3. That is, there may also be blocks of usable free space between the stored bit streams.

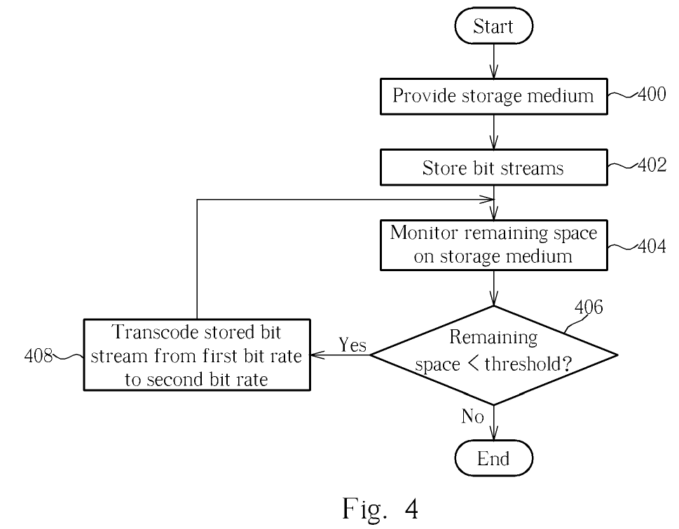

FIG. 4 shows a flowchart describing operations of storage medium management according to an exemplary embodiment. Provided that substantially the same result is achieved, the steps of the flowchart shown in FIG. 4 need not be in the exact order shown and need not be contiguous, that is, other steps can be intermediate. The flowchart contains the following steps:

Step 400: Provide a storage medium for recording encoded bit streams. For example, the storage medium could be a DVD disc 101 or a magnetic storage medium such a hard disk 130.

Step 402: Store encoded bit streams within the storage medium. For example, these bit streams could correspond to video programs, audio programs, a combinations of video/audio program, or any other type of bit stream having different available quality settings.

Step 404: Monitor a remaining space on the storage medium.

Step 406: Is the remaining space less than a predetermined threshold T₁? For example, is the remaining space less than a percentage of the total storage space available on the storage medium? If yes, proceed to step 408; otherwise, the remaining space is sufficient and storage management operations can end.

Step 408: Transcode a stored bit stream on the storage medium from a first bit rate to a second bit rate. Afterwards, return to step 404.

In some embodiments, in step 408, the second bit rate has a lower bit rate than the first bit rate. Therefore, after transcoding, the remaining space monitored in step 404 increases. As mentioned earlier, if the total remaining space of the storage medium provided in step 400 is below a threshold T₁, the storage system enters a storage efficient mode (step 408). With respect to FIG. 1, at this point, the storage medium management module 116 selects a stored bit stream for transcoding. For example, this selection can be performed by determining the largest of the encoded bit streams. Next, the storage medium management module 116 transcodes the stored bit stream with a reduced bit rate when the stored bit stream is not already encoded as the lowest bit rate, i.e. EP mode. The steps 404, 406, and 408 are repeated until the total remaining space is greater than the threshold T₁. In the case that all encoded video bit streams are already encoded with the lowest possible bit rate (e.g., EP mode), no bit stream can be transcoded and operations are ended.

It should also be noted that if there is only one codec 112 available in the storage system 100, the process of transcoding is performed in the “background” when no other normal recording operations are being performed. That is, the transcoding process is only performed when no scheduled or immediate recording operation is preformed. If multiple codecs 112 are available, the storage management operations can occur independently of normal recording operations. Additionally, although the figures and embodiments described throughout this description show an MPEG codec 112 for video bit streams, as will be easily observed by a personal of ordinary skill in the art, other embodiments of the present disclosure utilizing different encoding formats for different types of bit streams are also possible.

According to the exemplary embodiment, a method of storage medium management includes providing a storage medium; storing a plurality of encoded bit streams within the storage medium; monitoring a remaining storage space available within the storage medium; and if the remaining storage space is below a first threshold, transcoding a stored bit stream within the storage medium being encoded at a first bit rate to a second bit rate. By transcoding the stored bit stream to the second bit rate being lower than the first bit rate, the method of storage medium management according to the exemplary embodiment increases the remaining space available within the storage medium.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of storage medium management, the method comprising:
providing a storage medium;
storing a plurality of encoded bit streams within the storage medium;
monitoring a remaining storage space available within the storage medium; and
if the remaining storage space is below a threshold, transcoding a stored bit stream within the storage medium being encoded at a first bit rate to a second bit rate.

2. The method of claim 1, wherein the second bit rate is lower than the first bit rate.

3. The method of claim 1, further comprising encoding an incoming signal at the first bit rate to form the stored bit stream within the storage medium.

4. The method of claim 3, wherein the incoming signal is an incoming video signal, and the storage medium is for storing bit streams of encoded video data.

5. The method of claim 1, further comprising for each encoded bit stream within the storage medium, indicating which of the encoded bit streams can be transcoded by marking the encoded bit streams that can be transcoded as variable bit streams.

6. The method of claim 5, further comprising selecting one of the variable bit streams within the storage medium as the stored bit stream for transcoding.

7. The method of claim 1, further comprising selecting a bit stream within the storage medium as the stored bit stream for transcoding.

8. The method of claim 7, further comprising:
determining a largest sized bit stream within the storage medium that is encoded at the first bit rate; and
selecting the largest sized bit stream as the stored bit stream for transcoding.

9. The method of claim 7, wherein the selected bit stream is the bit stream within the storage medium having the highest bit rate.

10. The method of claim 7, wherein the selected bit stream is the bit stream within the storage medium having the earliest date or longest time since creation.

11. A storage system comprising:
a storage medium;
a codec coupled to the storage medium for storing a plurality of encoded bit streams within the storage medium; and
a storage medium management module coupled to the storage medium and the codec comprising:
a free space monitor for monitoring a remaining storage space available within the storage medium; and
a controller for controlling the codec to transcode a stored bit stream within the storage medium being encoded at a first bit rate to a second bit rate if the remaining storage space is below a threshold.

12. The storage system of claim 11, wherein the second bit rate is lower than the first bit rate.

13. The storage system of claim 11, wherein the codec is further for encoding an incoming signal at the first bit rate to form the stored bit stream within the storage medium.

14. The storage system of claim 13, wherein the incoming signal is an incoming video signal, and the storage medium is for storing bit streams of encoded video data.

15. The storage system of claim 11, wherein the storage medium management module further comprises a user settings module for indicating which of the encoded bit streams within the storage medium can be transcoded by marking the encoded bit streams that can be transcoded as variable bit streams.

16. The storage system of claim 6, wherein the storage medium management module further comprises a selection module for selecting one of the variable bit streams within the storage medium as the stored bit stream for transcoding.

17. The storage system of claim 11, wherein the storage medium management module further comprises a selection module for selecting a bit stream within the storage medium as the stored bit stream for transcoding.

18. The storage system of claim 17, wherein the selection module determines a largest sized bit stream within the storage medium that is encoded at the first bit rate; and selects the largest sized bit stream as the stored bit stream for transcoding.

19. The storage system of claim 17, wherein the selected bit stream is the bit stream within the storage medium having the highest bit rate.

20. The storage system of claim 17, wherein the selected bit stream is the bit stream within the storage medium having the earliest date or longest time since creation.

21. A video recording system comprising:
a storage medium;
a codec coupled to the storage medium for encoding an incoming video signal to form a plurality of encoded video bit streams within the storage medium; and
a storage medium management module coupled to the storage medium and the codec comprising:
a free space monitor for monitoring a remaining storage space available within the storage medium; and
a controller for controlling the codec to transcode a stored video bit stream within the storage medium being encoded at a first bit rate to a second bit rate if the remaining storage space is below a threshold.

22. The video recording system of claim 21, wherein the second bit rate is lower than the first bit rate.

23. The video recording system of claim 21, wherein the storage medium management module further comprises a selection module for selecting a video bit stream within the storage medium as the stored video bit stream for transcoding.

24. The video recording system of claim 23, wherein the selection module determines a largest sized video bit stream within the storage medium that is encoded at the first bit rate; and selects the largest sized video bit stream as the stored video bit stream for transcoding.

25. The video recording system of claim 23, wherein the selected video bit stream is the video bit stream within the storage medium having the highest bit rate.

26. The video recording system of claim 23, wherein the selected video bit stream is the video bit stream within the storage medium having the earliest date or longest time since creation.
